(19) United States
(12) Patent Application Publication
(10) Pub. No.: US 2018/0213223 A1
(43) Pub. Date: Jul. 26, 2018

(54) TRANSLATE DATA STRUCTURE TO VIDEO FRAME STRUCTURE

(71) Applicants: Jia-Yang LI, Shanghai (CN); Tong-Ning YIN, Shanghai (CN); ENTIT SOFTWARE LLC, Sunnyvale, CA (US)

(72) Inventors: Jia-Yang LI, Shanghai (CN); Tong-Ning YIN, Shanghai (CN)

(73) Assignee: ENT. SERVICES DEVELOPMENT CORPORATION LP, Houston, TX (US)

(21) Appl. No.: 15/749,498

(22) PCT Filed: Jul. 31, 2015
(86) PCT No.: PCT/CN2015/085722

§ 371 Date: Jan. 31, 2018

(51) Int. Cl. H04N 19/107; G06F 17/30; H04N 19/182; H04N 19/114

(52) U.S. Cl. CPC H04N 19/107; G06F 17/30333; H04N 19/114; H04N 19/182; G06F 17/30858

(57) ABSTRACT

Example implementations relate to translating a data structure to a video frame structure. For example, a computing device may perform a method of receiving analytic values of a data structure and converting the analytic values into raw pixel data such that each analytic value of the data structure is represented as a pixel in a video frame structure of pixels. The raw pixel data may be encoded into an I-frame in response to a determination that a difference between the raw pixel data and previous raw pixel data associated with previous analytic values exceeds a specified threshold. First data associated with at least one I-frame is retrieved in response to a request to view data changes exceeding the specified threshold.

### BACKGROUND

In the data warehouse context, a dimension is a structure that categorizes facts and measures in order to enable users to answer business questions. Commonly used dimensions may include people, products, places, time, and the like. Dimensions provide structured labeling information to otherwise unordered numeric measures.

### BRIEF DESCRIPTION OF THE DRAWINGS

Some examples of the present application are described with respect to the following figures:

FIG. 1 is a block diagram of an example system for translating a data structure to a video frame structure;

FIG. 2 is a block diagram of an example computing device for translating a data structure to a video frame structure; and

FIG. 3 is a flowchart of an example method for translating a data structure to a video frame structure.

### DETAILED DESCRIPTION

As described above, a dimension is a structure that categorizes facts and measures in order to enable users to answer business questions. A dimension may be provided within a data structure, which may be any suitable structure providing data. For example, a two-dimensional data structure may be a table showing sales data for various store locations on a particular day. A two-dimensional data structure may be used to create charts, histograms, figures, and the like, each of which may illustrate the data in various manners. However, these illustrations only show a particular data set at one given time without visibility into the changes to the data set over time. For example, a two-dimensional data structure associated with sales data for various stores may show the sales data for a given day, and subsequent sales data may be received for subsequent days. However, each data set for a given day may not provide insight into the changes in sales data between days.

Examples discussed herein provide techniques for accessing and viewing the differences in historical two-dimensional data in an efficient manner, allowing a user to quickly access data based on changes to the data. For example, data sets associated with a data structure may change over time, and the changes may be quickly accessed based on how much the data has changed. Two-dimensional data associated with a particular data structure may be represented a particular type of compressed frame within a video, and the type of compressed frame may indicate how much the data associated with that frame has changed. Using the example of two-dimensional sales data provided daily, each set of daily sales data may be translated to a video frame of pixels such that the two-dimensional data structure may be converted to a video frame structure. Each frame of pixels may be encoded and/or compressed using any suitable video compression techniques (e.g., the WebM video file format), and the compressed frame may be stored in a frame file with other compressed frames. For example, each two-dimensional data set may be translated to raw pixel data, and the raw pixel data may be encoded as an intra-frame (I-frame) or as a predicted frame (P-frame). An I-frame may be a frame that is coded without reference to any frame except itself. A P-frame may be a frame that is coded based on a reference frame. For example, a P-frame may be a frame that is encoded with respect to its preceding frame.

The frames in the frame file may be accessed to view I-frames and/or P-frames that may indicate the changes between the data sets. For example, for changes to a data set that exceed a specified threshold, the data set may be encoded as an I-frame that may indicate a large change to the data set. I-frames may be retrieved when a user requests to view large changes to data. For changes to a data set that does not exceed a specified threshold, the data set may be encoded as a P-frame that may indicate a small change to the data set. P-frames may be retrieved when a user requests to view small changes to data.

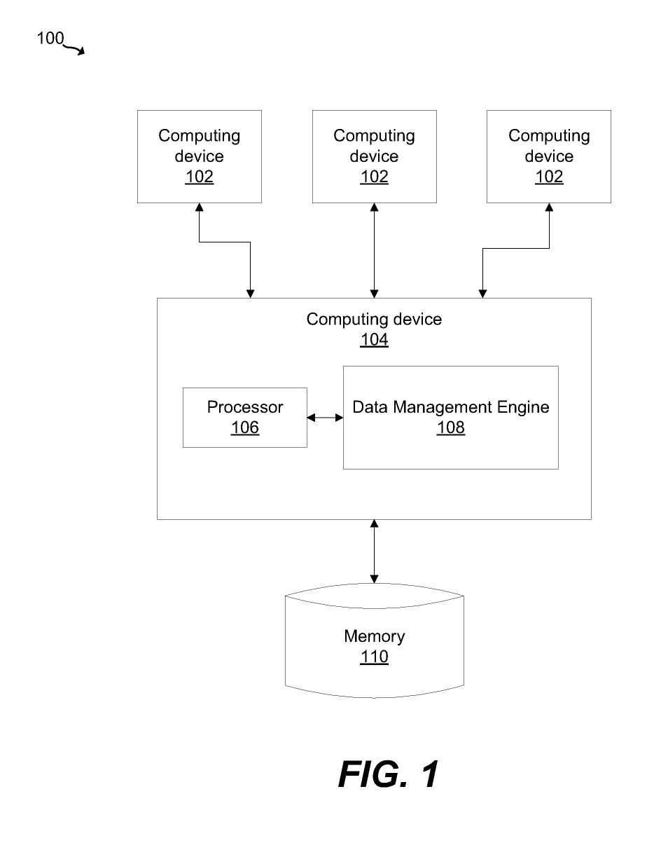

Referring now to the figures, FIG. 1 is a block diagram of an example system 100 for translating a data structure to a video frame structure. System 100 may include computing device 104, which may be any suitable computing device in communication with any number of computing devices 102. Computing device 104 may include a processor 106 and a data management engine 108 that may be any suitable engine that may cause the processor 106 to translate data structures received from computing devices 102 into video frame structures.

For example, computing devices 102 may each be associated with a retail store at a particular location, and each computing device 102 may send their daily sales data to computing device 104. The daily sales data may be in the form of a two-dimensional data structure (e.g., a two-dimensional table having daily sales data for various retail stores). Computing device 104 may translate the data in the two-dimensional data structure into raw pixel data, and the raw pixel data may be encoded as either an I-frame or a P-frame. For example, a data set may be encoded as a P-frame such that the P-frame represents the differences between that current data set and a data set preceding that current data set. In some examples, the first set of data associated a data structure may be encoded as an I-frame, as there is no preceding data set that can be used to create a P-frame. In some examples, if a difference between a current data set and its preceding data set exceeds a particular threshold, an I-frame may be created instead of a P-frame. In some examples, if an I-frame is created, a notification relating to the I-frame may be provided (e.g., to a user).

For example, the data management engine 108 of computing device 104 may cause processor 106 to receive analytic values of a data structure (e.g., a two-dimensional table of data). Analytic values of a data structure may be any suitable non-image values representing facts, measures, quantities, and the like, for analysis to answer analytic queries, and may be provided in a non-image data structure. For example, the analytic values may be sales data provided in a two-dimensional table of daily sales data for various retail stores. The analytic values may be translated into raw pixel data such that each analytic value of the data structure is represented as a pixel in a video frame structure of pixels. Raw pixel data for a given pixel is data associated with a color of the pixel, and the analytic values may be translated to raw pixel data representing a color corresponding to the analytic value. For example, for two-dimensional data, one dimension may be mapped to a raw video frame's row of pixels and the other dimension may be mapped to the raw video frame's column of pixels. As an example, the analytic values may be the 4-cell by 4-cell sales values shown in Table 1 below:

TABLE 1
Sales Data

| | Device 1 | Device 2 | Device 3 | Device 4 |
|---|---|---|---|---|
| Region 1 | 0.15 | 0.27 | 1.03 | 2.10 |
| Region 2 | 1.04 | 2.00 | 0.89 | 1.80 |
| Region 3 | 0.56 | 1.34 | 1.45 | 1.00 |
| Region 4 | 1.23 | 2.45 | 0.97 | 0.04 |

The analytic values of the data structure shown in Table 1 above may be translated to a 4-pixel by 4-pixel image by translating each analytic value in each of the cells to corresponding raw pixel data for each corresponding pixel. Raw pixel data for a grayscale image may be represented as a number within the range 0 to 255, where each number in the range represents a degree of luminance of the corresponding pixel (e.g., 0=black, 255=white). For Table 1, the analytic values may be translated to raw pixel data by multiplying the values in each cell by 100. An example of the raw pixel data for Table 1 is shown in Table 2 below:

TABLE 2
Raw Pixel Data

| | Device 1 | Device 2 | Device 3 | Device 4 |
|---|---|---|---|---|
| Region 1 | 15 | 27 | 103 | 210 |
| Region 2 | 104 | 200 | 89 | 180 |
| Region 3 | 56 | 134 | 145 | 100 |
| Region 4 | 123 | 245 | 97 | 4 |

The data in Table 2 may be the grayscale raw pixel data that corresponds to the data in Table 1. The grayscale raw pixel data in Table 1 may be formatted to the video frame structure by converting Table 1 into raw pixel data (e.g., data associated with pixels in a video frame of a video).

Once the analytic values are translated into raw pixel data, the data management engine 108 of computing device 104 may cause processor 106 to encode the raw pixel data into an I-frame in response to a determination that a difference between the raw pixel data and previous raw pixel data associated with previous analytic values exceeds a specified threshold. The data management engine 108 of computing device 104 may also cause processor 106 to encode the raw pixel data into a P-frame in response to a determination that the difference does not exceed the specified threshold. The specified threshold may be any suitable threshold representing a degree of change between the current analytic values and preceding analytic values, and the specified threshold may be used to determine whether raw pixel data is to be encoded as an I-frame or a P-frame. The threshold may be defined in any suitable manner (e.g., a user-defined threshold). For example, the threshold may define whether the difference between frames is great enough to warrant encoding the frame as an I-frame instead of a P-frame. Raw pixel data may be encoded to compressed frames (e.g., I-frames, P-frames, etc.) in any suitable manner. In some examples, the raw pixel data may be encoded based on the WebM standard, which is a video compression standard.

As subsequent data sets are received, the data sets may be encoded as I-frames and/or P-frames as described above. For example, subsequent analytic values of the data structure may be received, and the subsequent analytic values may be translated into subsequent raw pixel data. The data management engine 108 of computing device 104 may cause processor 106 to encode the subsequent raw pixel data into an I-frame in response to a determination that a subsequent difference between the subsequent raw pixel data and the raw pixel data exceeds the specified threshold and encode the subsequent raw pixel data into a P-frame in response to a determination that the subsequent difference does not exceed the specified threshold. In some examples, if the second difference exceeds the specified threshold beyond a particular amount, a notification and/or an alarm may be provided. In some examples, data that would otherwise be encoded as a P-frame may be encoded as an I-frame by force (e.g., by a user).

I-frames and P-frames associated with a particular data structure may be stored in a common frame file associated with the data structure. The frame file may be stored in memory 110, which may be any suitable type of memory device. The frame file may be accessed when a user wishes to view the various changes to data in the data structure. For example, computing device 104 may receive a request to view small changes to the data structure (e.g., the small changes being based on not exceeding the specified threshold), and data associated with P-frames in the frame file may be provided. In another example, computing device 104 may receive a request to view large changes (e.g., the large changes being based on exceeding the specified threshold) to the data structure, and data associated with I-frames in the frame file may be provided.

The data management engine 108 of computing device 104 may cause processor 106 to provide first data associated with at least one I-frame in response to a request to view data changes exceeding the specified threshold. For example, the first data provided may include a particular set of analytic values associated with the at least one I-frame. The data management engine 108 of computing device 104 may also cause processor 106 to provide second data associated with at least one P-frame in response to a request to view data changes not exceeding the specified threshold. For example, the second data provided may include a particular set of analytic values associated with at least one P-frame. The first data and the second data may be provided from the frame file that includes the I-frames and P-frames associated with the data structure.

Computing device 104 and computing devices 102 may be in communication with each other directly or over a network, which may be any suitable network, such as an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks. Each computing device 102 may be any suitable computing device having components that allow the computing device 102 to communicate data to computing device 104. For example, a computing device 102 may be a device at a retail store capable of communicating sales data to computing device 104.

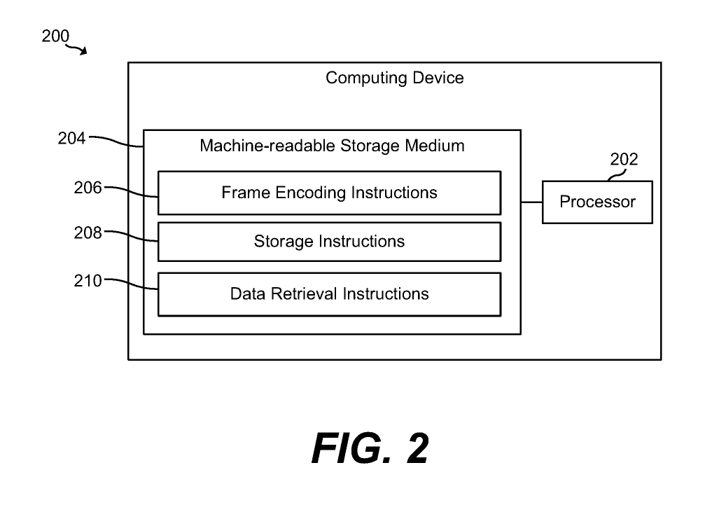

FIG. 2 is a block diagram of an example computing device 200 for translating a data structure to a video frame structure. Computing device 200 may be any suitable computing device (e.g., computing device 104 of FIG. 1) that may translate a data structure to a video frame structure.

Computing device 200 may be, for example, a web-based server, a local area network server, a cloud-based server, a notebook computer, a desktop computer, an all-in-one system, a tablet computing device, a mobile phone, an electronic book reader, a printing device, or any other electronic device suitable for translating a data structure to a video frame structure. Computing device 200 may include a processor 202 and a machine-readable storage medium 204. Computing device 200 may be in communication with other computing devices providing data relating to a data structure.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, and 210 to control a process of translating a data structure to a video frame structure. As an alternative or in addition to retrieving and executing instructions, processor 202 may include at least one electronic circuit that includes electronic components for performing the functionality of instructions 206, 208, 210, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an EPROM, an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, and 210 for translating analytic values of a data structure into raw pixel data such that each analytic value of the data structure is represented as a pixel in a video frame structure of pixels, compressing the raw pixel data into an I-frame in response to a determination that a difference between the raw pixel data and previous raw pixel data associated with previous analytic values exceeds a specified threshold, compressing the raw pixel data into a P-frame in response to a determination that the difference does not exceed the specified threshold, storing the I-frame or the P-frame in a frame file associated with the data structure, providing first data associated with at least one I-frame in response to a request to view data changes exceeding the specified threshold, and providing second data associated with at least one P-frame in response to a request to view data changes not exceeding the specified threshold.

Frame encoding instructions 206 may manage and control the translation of analytic values into raw pixel data and the compression of raw pixel data into either an I-frame or a P-frame. For example, analytic values of a data structure may be translated into raw pixel data such that each analytic value of the data structure is represented as a pixel in a video frame structure of pixels. The frame encoding instructions 206 may compress the raw pixel data into an I-frame in response to a determination that a difference between the raw pixel data and previous raw pixel data associated with previous analytic values exceeds a specified threshold. The frame encoding instructions 206 may also compress the raw pixel data into a P-frame in response to a determination that the difference does not exceed the specified threshold.

Storage instructions 208 may manage and control the storing of any encoded I-frames and/or P-frames in a frame file associated with the data structure. For example, once an I-frame and/or a P-frame is compressed, it is stored in the frame file associated with the corresponding data structure.

Data retrieval instructions 210 may manage and control the providing of first data from the frame file, where the first data is associated with at least one I-frame and provided in response to a request to view data changes exceeding the specified threshold. Data retrieval instructions 210 may also manage and control the providing of second data from the frame file, where the second data is associated with at least one P-frame and provided in response to a request to view data changes not exceeding the specified threshold.

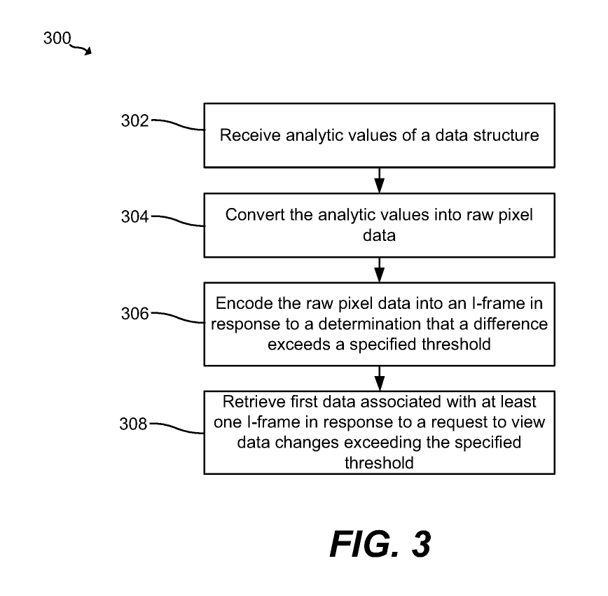

FIG. 3 is a flowchart of an example method 300 for translating a data structure to a video frame structure. Method 300 may be implemented using computing device 200 of FIG. 2.

Method 300 includes, at 302, receiving analytic values of a data structure. The analytic values may be any suitable values relating to the data structure (e.g., sales data for a particular day).

Method 300 also includes, at 304, convert the analytic values into raw pixel data such that each analytic value of the data structure is represented as a pixel in a video frame structure of pixels. For example, the analytic values may be converted into raw pixel data that may be grayscale pixel data.

Method 300 also includes, at 306, encoding the raw pixel data into an I-frame in response to a determination that a difference between the raw pixel data and previous raw pixel data associated with previous analytic values exceeds a specified threshold. The raw pixel data may be encoded into the I-frame using any suitable video compression techniques (e.g., WebM).

Method 300 also includes, at 308, retrieving first data associated with at least one I-frame in response to a request to view data changes exceeding the specified threshold.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and the like.

What is claimed is:

1. A computing device, comprising:
a processor to:
translate analytic values of a data structure into raw pixel data such that each analytic value of the data structure is represented as a pixel in a video frame structure of pixels;
in response to a determination that a difference between the raw pixel data and previous raw pixel data associated with previous analytic values exceeds a specified threshold, encode the raw pixel data into an I-frame;
in response to a determination that the difference does not exceed the specified threshold, encode the raw pixel data into a P-frame;
provide first data associated with at least one I-frame in response to a request to view data changes exceeding the specified threshold; and
provide second data associated with at least one P-frame in response to a request to view data changes not exceeding the specified threshold.

2. The computing device of claim 1, wherein the processor is further to store the I-frame or the P-frame in a frame file associated with the data structure, wherein the first data and the second data are provided from the frame file.

3. The computing device of claim 1, wherein the data structure is a two-dimensional table.

4. The computing device of claim 1, wherein the raw pixel data is encoded into the I-frame and wherein the processor is further to:
determine an amount by which the difference exceeds the specified threshold; and
provide a notification if the amount exceeds a specified limit.

5. The computing device of claim 1, wherein the first data provided includes a particular set of analytic values associated with the at least one I-frame.

6. The computing device of claim 1, wherein the second data provided includes a particular set of analytic values associated with the at least one P-frame.

7. The computing device of claim 1, wherein the processor is further to:
receive subsequent analytic values of the data structure;
translate the subsequent analytic values of the data structure into subsequent raw pixel data;
encode the subsequent raw pixel data into an I-frame in response to a determination that a subsequent difference between the subsequent raw pixel data and the raw pixel data exceeds the specified threshold; and
encode the subsequent raw pixel data into a P-frame in response to a determination that the subsequent difference does not exceed the specified threshold.

8. A method, comprising:
receiving, by a computing device, analytic values of a data structure;
converting, by the computing device, the analytic values into raw pixel data such that each analytic value of the data structure is represented as a pixel in a video frame structure of pixels;
encoding, by the computing device, the raw pixel data into an I-frame in response to a determination that a difference between the raw pixel data and previous raw pixel data associated with previous analytic values exceeds a specified threshold; and
retrieving, by the computing device, first data associated with at least one I-frame in response to a request to view data changes exceeding the specified threshold.

9. The method of claim 8, further comprising:
encoding, by the computing device, the raw pixel data into a P-frame in response to a determination that the difference does not exceed the specified threshold; and
retrieving, by the computing device, second data associated with at least one P-frame in response to a request to view data changes not exceeding the specified threshold.

10. The method of claim 8, further comprising:
storing, by the computing device, the I-frame in a frame file associated with the data structure, wherein the first data is retrieved from the frame file.

11. The method of claim 8, further comprising:
determining, by the computing device, an amount by which the difference exceeds the specified threshold; and
providing, by the computing device, a notification if the amount exceeds a specified limit.

12. A non-transitory machine-readable storage medium storing instructions that, when executed by at least one processor of a computing device, cause the computing device to:
translate analytic values of a data structure into raw pixel data such that each analytic value of the data structure is represented as a pixel in a video frame structure of pixels;
compress the raw pixel data into an I-frame in response to a determination that a difference between the raw pixel data and previous raw pixel data associated with previous analytic values exceeds a specified threshold;
compress the raw pixel data into a P-frame in response to a determination that the difference does not exceed the specified threshold;
store the I-frame or the P-frame in a frame file associated with the data structure;
provide, from the frame file, first data associated with at least one I-frame in response to a request to view data changes exceeding the specified threshold; and
provide, from the frame file, second data associated with at least one P-frame in response to a request to view data changes not exceeding the specified threshold.

13. The non-transitory machine-readable storage medium of claim 12, wherein the first data provided includes a particular set of analytic values associated with the at least one I-frame.

14. The non-transitory machine-readable storage medium of claim 12, wherein the second data provided includes a particular set of analytic values associated with the at least one P-frame.

15. The non-transitory machine-readable storage medium of claim 12, wherein the data structure is a two-dimensional table.
